(19) United States
(12) Patent Application Publication
(10) Pub. No.: US 2021/0094253 A1
(43) Pub. Date: Apr. 1, 2021

(54) MULTILAYER TUBE AND METHOD FOR MAKING SAME

(71) Applicant: Saint-Gobain Performance Plastics Corporation, Solon, OH (US)

(72) Inventors: Kevin M. McCauley, Town of Tonawanda, NY (US); Michael J. Tzivanis, Chicopee, MA (US); Charles S. Golub, Westford, MA (US); Mark F. Colton, Rootstown, OH (US); Lily Lei, Morristown, NJ (US); Gerald H. Ling, Ardmore, PA (US); James Ludlow, Medina, OH (US)

(21) Appl. No.: 17/032,891

(22) Filed: Sep. 25, 2020

Related U.S. Application Data
(60) Provisional application No. 62/907,088, filed on Sep. 27, 2019.

(51) Int. Cl. B32B 1/08; B32B 25/14; B32B 25/16; B29C 48/00; B29C 48/09; B29C 48/21

(52) U.S. Cl. CPC B32B 1/08; B32B 25/14; B32B 25/16; B29C 48/022; B29K 2027/12; B29C 48/21; B32B 2307/536; B32B 2250/02; B32B 2597/00; B29C 48/09

(57) ABSTRACT

A multilayer tube includes an inner layer including a crosslinked fluoroelastomer rubber; and an outer layer including a crosslinked non-fluoroelastomer rubber, wherein the multilayer tube has a shore A hardness of about 40 to about 90.

### CROSS-REFERENCE TO RELATED APPLICATION(S)

This application claims priority under 35 U.S.C. § 119(e) to U.S. Provisional Patent Application No. 62/907,088, entitled “MULTILAYER TUBE AND METHOD FOR MAKING SAME,” by Kevin M. MCCAULEY, Michael J. TZIVANIS, Charles S. GOLUB, Mark F. COLTON, Lily LEI and Gerald H. LING, filed Sep. 27, 2019, which is assigned to the current assignee hereof and incorporated herein by reference in its entirety.

### FIELD OF THE DISCLOSURE

This application in general, relates to a multilayer tube and a method for making same, and in particular, relates to a multilayer fluid conduit.

### BACKGROUND

Hoses and tubing are used in a variety of industries including cleaning and household industries, food processing, chemical industries, and pharmaceutical industries. In such industries, fluid conduits that have a low surface energy inner surface are used because they are easy to clean and resistant to contaminants. In particular, such industries are turning to low surface energy polymers such as fluoropolymers. However, such fluoropolymers are expensive and often have undesirable properties for certain applications.

Industry uses such fluoropolymers as liners for fluid conduit. However, many fluoropolymers desirable as an inner surface are difficult to adhere to other surfaces. For instance, when exposed to certain solvents, such as laundry detergents, delamination between a fluoropolymer and a substrate typically occurs. Further, many fluoropolymers also are inflexible, making the material undesirable for applications that require stress, such as bend radius, pressures, and the like.

As such, an improved multilayer polymer article would be desirable.

### SUMMARY

In an embodiment, a multilayer tube includes an inner layer including a crosslinked fluoroelastomer rubber; and an outer layer including a crosslinked non-fluoroelastomer rubber, wherein the multilayer tube has a shore A hardness of about 40 to about 90.

In another embodiment, a method of forming a multilayer tube includes: providing an inner layer including a crosslinked fluoroelastomer rubber; and providing an outer layer including a crosslinked non-fluoroelastomer rubber, wherein the multilayer tube has a shore A hardness of about 40 to about 90.

In a particular embodiment, a multilayer tube includes: an inner layer including a crosslinked fluoroelastomer rubber, wherein the crosslinked fluoroelastomer rubber includes a terpolymer of an ethylene, a tetrafluoroethylene (TFE), and perfluoromethylvinyl ether (PMVE); and an outer layer including a diene elastomer.

### BRIEF DESCRIPTION OF THE DRAWING(S)

The present disclosure may be better understood, and its numerous features and advantages made apparent to those skilled in the art by referencing the accompanying drawings.

FIG. 1 includes an illustration of an exemplary multilayer tube.

The use of the same reference symbols in different drawings indicates similar or identical items.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises”, “comprising”, “includes”, “including”, “has”, “having” or any other variation thereof, are open-ended terms and should be interpreted to mean “including, but not limited to. . . .” These terms encompass the more restrictive terms “consisting essentially of” and “consisting of.” In an embodiment, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in reference books and other sources within the structural arts and corresponding manufacturing arts. Unless indicated otherwise, all measurements are at about 23° C. +/−5° C. per ASTM, unless indicated otherwise.

In a particular embodiment, a multilayer tube is provided. The multilayer tube includes at least an inner layer and an outer layer. In an embodiment, the inner layer includes a crosslinked fluoroelastomer rubber. The outer layer includes a crosslinked non-fluoroelastomer rubber. Advantageously, the multilayer tube has properties for applications that include exposure to chemical solutions, dynamic stress, or combination thereof. A method of forming a multilayer tube is further provided.

An exemplary crosslinked fluoroelastomer rubber of the inner layer may be formed of a homopolymer, copolymer, terpolymer, or polymer blend formed from a monomer, such as tetrafluoroethylene, hexafluoropropylene, chlorotrifluoroethylene, trifluoroethylene, vinylidene fluoride, vinylidene difluoride, vinyl fluoride, perfluoropropyl vinyl ether, perfluoromethyl vinyl ether, ethylene, propylene, or any combination thereof. In an embodiment, the crosslinked fluoroelastomer rubber includes at least one monomer unit having a chemical moiety that bonds the crosslinked fluoroelastomer rubber to the crosslinked non-fluoroelastomer rubber of the outer layer. An exemplary crosslinked fluoroelastomer rubber includes at least two monomer units, wherein the monomer units include vinylidene fluoride, hexafluoropropylene, tetrafluoroethylene, perfluoromethylvinyl ether, ethylene, polypropylene, or combination thereof, wherein at least one monomer unit of the fluoroelastomer rubber includes a fluorine atom.

In an embodiment, the crosslinked fluoroelastomer rubber includes a terpolymer of ethylene, tetrafluoroethylene (TFE), and perfluoromethylvinyl ether (PMVE), a copolymer of hexafluoropropylene and vinylidene fluoride, a terpolymer of tetrafluoroethylene, hexafluoropropylene, and vinylidene fluoride, a terpolymer of tetrafluoroethylene, perfluoromethylvinyl ether, and vinylidene fluoride, a terpolymer of tetrafluoroethylene, propylene, and vinylidene fluoride, a pentapolymer of tetrafluoroethylene, hexafluoropropylene, ethylene, perfluoromethylvinyl ether, and vinylidene fluoride, any blend, or combination thereof. Typically, any nominal fluorine content greater than about 60 weight %, such as about 60 weight % to about 80 weight %, or even about 60 weight % to about 70 weight % is envisioned for the crosslinked fluoroelastomer rubber. It will be appreciated that the nominal fluorine content can be within a range between any of the minimum and maximum values noted above.

In an example, the crosslinked fluoroelastomer rubber includes a terpolymer of ethylene, tetrafluoroethylene (TFE), and perfluoromethylvinyl ether (PMVE). In an embodiment, the terpolymer of ethylene, tetrafluoroethylene (TFE), and perfluoromethylvinyl ether (PMVE) has a nominal polymer fluorine content of about 65 weight % to about 70 weight %, such as about 67 weight %. It will be appreciated that the nominal fluorine content can be within a range between any of the minimum and maximum values noted above. Prior to cure, the monomeric units of the fluoroelastomer rubber are not crosslinked. When subjected to cure, a crosslinked fluoroelastomer rubber is formed. In particular, the cure may provide intralayer crosslinking within the crosslinked fluoroelastomer rubber, interlayer crosslinking between the inner layer and the outer layer, or combination thereof.

In a further embodiment, the inner layer may include any additive envisioned. The additive may include, for example, a curing agent, an antioxidant, a filler, an ultraviolet (UV) agent, a dye, a pigment, an anti-aging agent, a plasticizer, the like, or combination thereof. In an embodiment, the curing agent is a cross-linking agent provided to increase and/or enhance cros slinking of the fluoroelastomer rubber composition of the inner layer. In a further embodiment, the use of a curing agent may provide desirable properties such as decreased permeation of small molecules and improved elastic recovery of the inner layer compared to an inner layer that does not include a curing agent. Any curing agent is envisioned such as, for example, a dihydroxy compound, a diamine compound, an organic peroxide, or combination thereof. An exemplary dihydroxy compound includes a bisphenol AF. An exemplary diamine compound includes hexamethylene diamine carbamate. In an embodiment, the curing agent is an organic peroxide. Any amount of curing agent is envisioned. Alternatively, the inner layer may be substantially free of crosslinking agents, curing agents, photoinitiators, fillers, plasticizers, or a combination thereof. “Substantially free” as used herein refers to less than about 1.0% by weight, or even less than about 0.1% by weight of the total weight of the fluoroelastomer rubber of the inner layer.

In a particular embodiment, the inner layer includes at least 70% by weight of the fluoroelastomer rubber. For example, the inner layer may include at least 85% by weight fluoroelastomer rubber, such as at least 90% by weight, at least 95% by weight, or even 100% by weight of the fluoroelastomer rubber. In an example, the inner layer may consist essentially of the fluoroelastomer rubber. In a particular example, the inner layer may consist essentially of the terpolymer of ethylene, tetrafluoroethylene (TFE), and perfluoromethylvinyl ether (PMVE). As used herein, the phrase “consists essentially of” used in connection with the fluoroelastomer rubber of the inner layer precludes the presence of non-fluorinated polymers and fluorinated monomers that affect the basic and novel characteristics of the fluoroelastomer rubber, although, commonly used processing agents and additives such as antioxidants, fillers, UV agents, dyes, pigments, anti-aging agents, and any combination thereof may be used in the fluoroelastomer rubber.

In a particular embodiment, the crosslinked fluoroelastomer rubber has a desirable hardness. For instance, the hardness of the inner layer is shore D of less than about 95, such as a shore A of about 20 to shore D of about 95, such as shore A of about 20 to shore D of about 65, such as shore A of about 20 to about 80 as measured by ASTM D2240. In an embodiment, the hardness of the inner layer is a shore A of less than about 80, such as about 20 to about 80, such as about 40 to about 80, or even about 40 to about 60. It will be appreciated that the hardness can be within a range between any of the minimum and maximum values noted above.

The crosslinked fluoroelastomer rubber of the inner layer typically is a flexible material. For instance, the crosslinked fluoroelastomer rubber has a flexural modulus of greater than about 50 MPa, such as a flexural modulus of about 50 MPa to about 850 MPa, such as about 50 MPa to about 300 MPa as measured by ASTM D790. In an embodiment, the crosslinked fluoroelastomer rubber has an elongation at yield of greater than about 5%, such as greater than about 7%, such as greater than about 8%, or even greater than about 10% as measured by ASTM D790. It will be appreciated that the flexural modulus and elongation at yield can be within a range between any of the minimum and maximum values noted above.

The multilayer tube further includes an outer layer. In an embodiment, the outer layer is a crosslinked non-fluoroelastomer rubber. In an embodiment, the crosslinked non-fluoroelastomer rubber of the outer layer includes any thermoplastic vulcanizate, thermoplastic polymer, thermoset polymer, or combination thereof envisioned that is free of a fluorine atom. In an embodiment, the crosslinked non-fluoroelastomer rubber includes a thermoset polymer. In an embodiment, the crosslinked non-fluoroelastomer rubber includes at least one monomer unit having a chemical moiety that bonds the crosslinked non-fluoroelastomer rubber to the crosslinked fluoroelastomer rubber of the inner layer with the proviso that the monomer unit does not include a fluorine atom. In an embodiment, the crosslinked non-fluoroelastomer rubber of the outer layer includes a thermoplastic polyurethane, a thermoset urethane, a diene elastomer, a styrene-based elastomer, a polyolefin elastomer, a flexible polyvinyl chloride (PVC), an isoprene, a thermoplastic isoprene composite, a natural rubber, any alloy, any blend, or combination thereof. Prior to cure, the monomeric units of the non-fluoroelastomer rubber are not crosslinked. When subjected to cure, a crosslinked non-fluoroelastomer rubber is formed. In particular, the cure may provide intralayer crosslinking within the crosslinked non-fluoroelastomer rubber, interlayer crosslinking between the inner layer and the outer layer, or combination thereof.

In a particular example, the non-fluoroelastomer rubber of the outer layer includes a diene elastomer. The diene elastomer may be a copolymer formed from at least one diene monomer. For example, the diene elastomer may be a copolymer of ethylene, propylene and diene monomer (EPDM), a thermoplastic EPDM composite, or combination thereof. An exemplary diene monomer may include a conjugated diene, such as butadiene, isoprene, chloroprene, or the like; a non-conjugated diene including from 5 to about 25 carbon atoms, such as 1,4-pentadiene, 1,4-hexadiene, 1,5-hexadiene, 2,5-dimethyl-1,5-hexadiene, 1,4-octadiene, or the like; a cyclic diene, such as cyclopentadiene, cyclohexadiene, cyclooctadiene, dicyclopentadiene, or the like; a vinyl cyclic ene, such as 1-vinyl-1-cyclopentene, 1-vinyl-1-cyclohexene, or the like; an alkylbicyclononadiene, such as 3-methylbicyclo-(4,2,1)-nona-3,7-diene, or the like; an indene, such as methyl tetrahydroindene, or the like; an alkenyl norbornene, such as 5-ethylidene-2-norbornene, 5-butylidene-2-norbornene, 2-methallyl-5-norbornene, 2-isopropenyl-5-norbornene, 5-(1,5-hexadienyl)-2-norbornene, 5-(3,7-octadienyl)-2-norbornene, or the like; a tricyclodiene, such as 3-methyltricyclo (5,2,1,0²,6)-deca-3,8-diene or the like; or any combination thereof. In an embodiment, the non-fluoroelastomer rubber includes a polyisoprene, a polybutadiene, or combination thereof. In a more particular embodiment, the non-fluoroelastomer rubber includes a cis-polyisoprene, a cis-polybutadiene, or combination thereof, wherein the “cis” content is greater than 85% cis-addition.

In an additional example, the crosslinked non-fluoroelastomer rubber of the outer layer may include a styrene-based elastomer. The styrene-based elastomer typically includes a styrenic based block copolymer that includes, for example, a multiblock copolymer such as a diblock, triblock, polyblock, or any combination thereof. In a particular embodiment, the styrenic based block copolymer is a block copolymer having AB units. Typically, the A units are alkenyl arenes such as a styrene, an alpha-methylstyrene, para-methylstyrene, para-butyl styrene, or combination thereof. In a particular embodiment, the A units are styrene. In an embodiment, the B units include alkenes such as butadiene, isoprene, ethylene, butylene, propylene, or combination thereof. In a particular embodiment, the B units are ethylene, isoprene, or combinations thereof. Exemplary styrenic based block copolymers include a diblock styrenic copolymer such as styrene butadiene rubber (SBR) and triblock styrenic block copolymers (SBC) such as styrene-butadiene-styrene (SBS), styrene-isoprene-styrene (SIS), styrene-ethylene butylene-styrene (SEBS), styrene-ethylene propylene-styrene (SEPS), styrene-ethylene-ethylene-butadiene-styrene (SEEBS), styrene-ethylene-ethylene-propylene-styrene (SEEPS), styrene-isoprene-butadiene-styrene (SIBS), or combinations thereof. In an embodiment, the styrenic based block copolymer is saturated, i.e. does not contain any free olefinic double bonds. In an embodiment, the styrenic based block copolymer contains at least one free olefinic double bond, i.e. an unsaturated double bond. In a particular embodiment, the styrene-based elastomer is a styrene-ethylene based copolymer, a styrene isoprene based copolymer, a blend, or combination thereof.

In an example, the polyolefin elastomer of the outer layer may include a homopolymer, a copolymer, a terpolymer, an alloy, or any combination thereof formed from a monomer, such as ethylene, propylene, butene, pentene, methyl pentene, octene, or any combination thereof. An exemplary polyolefin elastomer includes high density polyethylene (HDPE), medium density polyethylene (MDPE), low density polyethylene (LDPE), ultra or very low density polyethylene (VLDPE), ethylene propylene copolymer, ethylene butene copolymer, polypropylene (PP), polybutene, polybutylene, polypentene, polymethylpentene, polystyrene, ethylene propylene rubber (EPR), ethylene octene copolymer, blend thereof, mixture thereof, and the like. The polyolefin elastomer further includes any olefin-based random copolymer, olefin-based impact copolymer, olefin-based block copolymer, olefin-based specialty elastomer, olefin-based specialty plastomer, metallocene-based olefin, blend thereof, mixture thereof, and the like.

In a particular example, the non-fluoroelastomer rubber of the outer layer is self-bonding. For a self-bonding polymer, a modification to the non-fluoroelastomer rubber, either through grafting chemically active functionalities onto the polymeric chains within the non-fluoroelastomer rubber or through incorporation of a separated chemical component into the matrix of the non-fluoroelastomer rubber, leads to enhanced bonding between the non-fluoroelastomer rubber and the layer it is directly adjacent to. Any chemically active functionalities or chemical components are envisioned.

In an exemplary embodiment, the crosslinked non-fluoroelastomer rubber of the outer layer may further include any reasonable additive such as a curing agent, a photoinitiator, a filler, a plasticizer, or any combination thereof. Any curing agent is envisioned that increases and/or enhances crosslinking of the non-fluoroelastomer rubber of the outer layer. In a further embodiment, the use of a curing agent may provide desirable properties such as decreased permeation of small molecules and improved elastic recovery of the outer layer compared to an outer layer that does not include a curing agent. Any curing agent is envisioned such as, for example, a sulfur compound, an organic peroxide, or combination thereof. In an embodiment, the curing agent is an organic peroxide. Any reasonable amount of curing agent is envisioned. Alternatively, the crosslinked non-fluoroelastomer rubber of the outer layer may be substantially free of a curing agents, a photoinitiator, a filler, a plasticizer, or a combination thereof. “Substantially free” as used herein refers to less than about 1.0% by weight, or even less than about 0.1% by weight of the total weight of the crosslinked non-fluoroelastomer rubber of the outer layer.

In an embodiment, the crosslinked non-fluoroelastomer rubber of the outer layer has a desirable shore hardness. In a particular embodiment, the crosslinked non-fluoroelastomer rubber of the outer layer has a shore hardness that is less than the shore hardness of the crosslinked fluoroelastomer rubber of the inner layer. In another embodiment, the crosslinked non-fluoroelastomer rubber of the outer layer has a shore hardness that is greater than the shore hardness of the crosslinked fluoroelastomer rubber of the inner layer. In yet another embodiment, the crosslinked non-fluoroelastomer rubber of the outer layer has a shore hardness that is the same as the shore hardness of the crosslinked fluoroelastomer rubber of the inner layer. For instance, the outer layer includes a crosslinked non-fluoroelastomer rubber having a shore D of less than about 95, such as a shore A of about 20 to shore D of about 95, such as shore A of about 20 to shore D of about 65, such as shore A of about 20 to about 80 as measured by ASTM D2240. In an embodiment, the hardness of the outer layer is a shore A of less than about 80, such as about 20 to about 80, such as about 40 to about 80, or even about 40 to about 60. It will be appreciated that the hardness can be within a range between any of the minimum and maximum values noted above.

In another example, the crosslinked non-fluoroelastomer rubber of the outer layer has further desirable properties. In an embodiment, the crosslinked non-fluoroelastomer rubber of the outer layer has a much higher flexibility than the inner layer as defined by a combination of durometer (or hardness), tensile strength, elongation, and flexibility tests. In an embodiment, the outer layer has a recoverable deformation greater than 150% and the inner layer has a recoverable deformation less than 150% as per ASTM D1646.

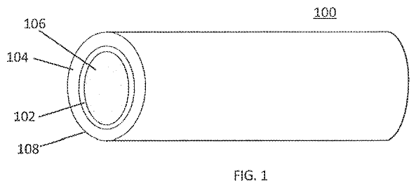

In an example, FIG. 1 includes an illustration of an exemplary multilayer tube 100 that has two layers. For example, an inner layer 102 may be bonded to an outer layer 104. In particular, the inner and outer layers (102, 104) are in direct contact absent any intervening layers, such as adhesive layers. Inner layer 102 has an inner lumen 106 that defines a passage for fluid to flow through. Inner layer 102 is typically a crosslinked fluoroelastomer rubber and outer layer 104 is typically a crosslinked non-fluoroelastomer rubber as described above.

Returning to FIG. 1, the inner layer 102 is thinner than the outer layer 104. For example, the total thickness of the layers of the multilayer tube 100 may be at least 3 mils to about 1000 mils, such as about 3 mils to about 500 mils, or even about 3 mils to about 100 mils. In an embodiment, the inner layer 102 has a thickness in a range of about 0.1 mil to about 100 mil, such as a range of about 0.5 mil to about 100 mil, such as a range of about 1 mil to about 100 mil, such as a range of about 1 mil to about 50 mil, such as a range of about 1 mil to about 10 mil, or even a range of about 1 mil to about 2 mil. The outer layer 104 and optionally other layers may make up the difference. In an example, the outer layer 104 may have a thickness in a range of about 0.1 mils to about 100 mils, such as a range of about 1 mil to about 100 mil, such as a range of about 2 mil to about 50 mils, or even a range of about 5 mil to about 50 mil. In a further example, the ratio of the thickness of the outer layer 104 relative to the thickness of the inner layer 102 is at least about 1.0, such as at least about 1.5, such as at least about 2.0, such as at least about 5.0, or even at least about 10.0. It will be appreciated that the thickness values can be within a range between any of the minimum and maximum values noted above.

In an embodiment, at least one layer may be treated to improve adhesion between the inner layer 102 and the outer layer 104. Any treatment is envisioned that increases the adhesion between two adjacent layers. For instance, a surface of the inner layer 102 that is directly adjacent to the outer layer 104 is treated. Further, a surface of the outer layer 104 that is directly adjacent to the inner layer 102 is treated. In an embodiment, the treatment may include surface treatment, chemical treatment, sodium etching, use of a primer, or any combination thereof. In an embodiment, the treatment may include corona treatment, UV treatment, electron beam treatment, flame treatment, scuffing, sodium naphthalene surface treatment, or any combination thereof.

In an embodiment, any post-cure steps may be envisioned. In particular, the post-cure step includes any thermal treatment, radiation treatment, or combination thereof. Any thermal conditions are envisioned. In an embodiment, the post-cure step includes any radiation treatment such as, for example, e-beam treatment, gamma treatment, or combination thereof. In an example, the gamma radiation or ebeam radiation is at about 0.1 MRad to about 50 MRad. In a particular embodiment, the post-cure step may be provided to eliminate any residual volatiles, increase interlayer and/or intralayer crosslinking, or combination thereof.

While only two layers are illustrated in FIG. 1, the multilayer tube 100 may further include additional layers (not illustrated). Any additional layer may be envisioned such as a tie layer, an elastomeric layer, a reinforcement layer, or any combination thereof. Any position of the additional layer with respect to the inner layer and outer layer is envisioned. For instance, any additional layer may be disposed on surface 108 of the outer layer 104. In an example, an additional layer such as a reinforcement layer (not shown) may be incorporated within or between additional layers disposed in proximity to surface 108 of the outer layer 104. An exemplary reinforcement layer may include a wire, a fiber, a fabric, such as a woven fabric, a braid, or any combination thereof, formed of a material such as polyester, an adhesion modified polyester, a polyamide, a polyaramid, a glass, a metal, or a combination thereof. In an embodiment, the multilayer tube consists of the inner layer and the outer layer as described.

In a particular embodiment, the multilayer tube, such as a fluid conduit is formed by providing the inner layer including the fluoroelastomer rubber and applying the outer layer to directly contact the bond surface of the inner layer, such as without intervening adhesive or bond enhancing layers. The fluoroelastomer rubber may be provided by any method envisioned and is dependent upon the fluoroelastomer rubber chosen for the inner layer. In an embodiment, the crosslinked fluoroelastomer rubber is melt processable. “Melt processable” as used herein refers to a fluoroelastomer rubber that can melt and flow to extrude in any reasonable form such as films, tubes, fibers, molded articles, or sheets. For instance, the melt processable fluoroelastomer rubber is a flexible material. In an embodiment, the fluoroelastomer rubber is extruded, injection molded, or mandrel wrapped. In an exemplary embodiment, the fluoroelastomer rubber is extruded. In an example, the bond surface of the inner layer is prepared with a surface treatment. In an embodiment, the fluoroelastomer rubber may be cured before, after, or during application of any further layers on the multilayer tube. The inner layer may be cured in place using a variety of curing techniques such as via heat, radiation, or any combination thereof. Curing provides a crosslinked fluoroelastomer rubber inner layer. For instance, when cured, a chemical moiety of the monomer units of the fluoroelastomer rubber forms bonds with the non-fluoroelastomer rubber of the outer layer.

The outer layer includes a non-fluoroelastomer rubber as described above. The non-fluoroelastomer rubber may be provided by any method envisioned and is dependent upon the non-fluoroelastomer rubber chosen for the outer layer. The method may further include providing the outer layer by any method. Providing the outer layer depends on the non-fluoroelastomer rubber material chosen for the outer layer. In an embodiment, the outer layer is a “melt processable” non-fluoroelastomer rubber. “Melt processable non-fluoroelastomer rubber” as used herein refers to a polymer that can melt and flow to extrude in any reasonable form such as films, tubes, fibers, molded articles, or sheets. In an embodiment, the outer layer is extruded or injection molded. In an exemplary embodiment, the outer layer may be extruded. In a particular embodiment, the outer layer is extruded over the fluoroelastomer rubber layer and the outer layer is cured. The outer layer may be cured in place using a variety of curing techniques such as via heat, radiation, or any combination thereof. Curing provides a crosslinked non-fluoroelastomer rubber outer layer. For instance, when cured, a chemical moiety of the monomer units of the non-fluoroelastomer rubber forms bonds with the fluoroelastomer rubber of the inner layer.

In a particular embodiment, the inner layer is the fluoroelastomer rubber layer and the outer layer is the non-fluoroelastomer rubber. In an exemplary embodiment, the inner layer is provided by heating the fluoroelastomer rubber to an extrusion viscosity and extruding the fluoroelastomer rubber to form the inner layer. The outer layer is provided by heating the non-fluoroelastomer rubber to an extrusion viscosity and then extruding the non-fluoroelastomer rubber. In a particular embodiment, the difference of the viscosity of the fluoroelastomer rubber of the inner layer and the viscosity of the non-fluoroelastomer rubber of the outer layer is not greater than 25%, such as not greater than 20%, not greater than 10%, or even 0% to provide for improved processing. Although not being bound by theory, it is surmised that the viscosity similarity improves the adhesion of the inner layer to the outer layer. In an embodiment, the inner layer and the outer layer are co-extruded. Advantageously, the inner layer and the outer layer may also be cured at the same time, which may enhance the adhesive strength between the two layers. In particular, the inner layer and the outer layer have cohesive strength between the two layers, i.e. cohesive failure occurs wherein the structural integrity of the inner layer and/or the outer layer fails before the bond between the two materials fails.

Although generally described as a multilayer tube, any reasonable polymeric article can be envisioned. The polymeric article may alternatively take the form of a film, a washer, or a fluid conduit. For example, the polymeric article may take the form or a film, such as a laminate, or a planar article, such as a septa or a washer. In another example, the polymeric article may take the form of a fluid conduit, such as tubing, a pipe, a hose or more specifically flexible tubing, transfer tubing, pump tubing, chemical resistant tubing, warewash tubing, laundry tubing, high purity tubing, smooth bore tubing, fluoroelastomer lined pipe, or rigid pipe, or any combination thereof. In a particular embodiment, the multilayer tube can be used as tubing or hosing where chemical resistance and pumpability is desired. For instance, a multilayer tubing is a fuel tube, a pump tube, such as for chemical or laundry detergent dispensing, a peristaltic pump tube, or a liquid transfer tube, such as a chemically resistant liquid transfer tube.

Tubing includes an inner surface that defines a central lumen of the tube. For instance, tubing may be provided that has any useful diameter size for the particular application chosen. In an embodiment, the tubing may have an outside diameter (OD) of up to about 5.0 inches, such as about 0.25 inch, 0.50 inch, and 1.0 inch. In an embodiment, the tubing may have an inside diameter (ID) of about 0.03 inches to about 4.00 inches, such as about 0.06 inches to about 1.00 inches. It will be appreciated that the inside diameter can be within a range between any of the minimum and maximum values noted above. Multilayer tubing as described advantageously exhibits desired properties such as increased lifetime. For example, the multilayer tube may have a pump life of at least about 6 months in a peristaltic pump with the pump running under intermittent conditions such with one minute on, 5 minutes off for 10 hours a day. In an embodiment, the multilayer tube has a flow rate that changes by less than about 30%, such as less than about 20%, such as less than about 10%, or even less than about 5%.

In embodiment, the resulting multilayer tube may have further desirable physical and mechanical properties. In an embodiment, the crosslinked fluoroelastomer rubber may be particularly suited with a desirable resistance to a variety of chemical solutions. For instance, the crosslinked fluoroelastomer rubber has a percent volume change in a chemical solution with a pH of about 1 to about 14 for 168 hours at 158° F. of no greater than 20%, or even no greater than 15%. Chemical solutions with a pH of about 1 to about 14 include, for example, basic chemicals, detergents, acidic chemicals, sours, oxidizers, the like, or any combination thereof. Exemplary basic chemicals include, but are not limited to, potassium hydroxide, sodium hydroxide at 40% or less, and the like. For laundry and warewashing, these basic chemicals are typically a detergent. As for acidic chemicals, strong inorganic acids include, but are not limited to, hydrochloric acid, sulfuric acid, nitric acid, phosphoric acid, as well as weaker acids such as fluorosilicic acid and oxalic acid at 10% or less, and the like. For laundry and warewashing, these acidic chemicals are typically known as sours. Exemplary strong oxidizers include, but are not limited to, sodium hypochlorite (bleach) and organic peracids, such as peracetic acid, or combination thereof. Typically, the commercial laundry market considers these as de-stainers or bleaches. In an embodiment, the crosslinked fluoroelastomer rubber has a percent volume change in an oxidizer for 168 hours at 73° F. of no greater than 30%, such as no greater than 20%, or even no greater than 10%. In a particular embodiment, the crosslinked fluoroelastomer rubber has a percent volume change in an oxidizer, such as methanol, for 168 hours at 73° F. of no greater than 30%, such as no greater than 20%, or even no greater than 10%.

In an embodiment, the crosslinked fluoroelastomer rubber of the multilayer tube has a percent volume change in a small molecule formulation for 168 hours at 73° F. of no greater than 100%, such as no greater than 50%, or even not greater than 25%. A “small molecule formulation” includes a certain class of laundry detergents that use citrus aromas as part of their formulation. These formulations may contain, for example, alcohols, ketones, aldehydes, and other small molecules, such as citrus terpenes at less than 15%. Other small molecules include, by are not limited to isopropanol, 2-butoxy ethanol, D-limonene, citrus terpenes, dipropylene glycol monobutyl ether; glycol ether DPnB; 1-(2-butoxy-1-methylethoxy)propan-2-ol, diethylene glycol butyl ether; 2-(2-butoxyethoxy)-ethanol, fatty acids, tall-oil, sulfonic acids, C14-16-alkane hydroxyl, C14-16-alkene, sodium salt, C12-16 ethoxylated alcohols, the like, or any combination thereof.

In an embodiment, the multilayer tubes are kink-resistant and appear transparent or at least translucent. In particular, the multilayer tube has desirable flexibility and substantial clarity or translucency. For example, the multilayer tube has a bend radius of at least 0.5 inches. For instance, the multilayer tube may advantageously produce low durometer tubes. For example, the multilayer tube has a Shore A durometer of between about 20 and about 90, such as between about 40 to about 90 having desirable mechanical properties may be formed. In an embodiment, the materials that make up the multilayer tube have a composite flexural modulus of at least about 50 MPa, such as about 50 MPa to about 200 MPa, as measured by ASTM D790. Such properties are indicative of a flexible material. It will be appreciated that the hardness and flexural modulus can be within a range between any of the minimum and maximum values noted above.

Applications for the multilayer tubing are numerous. In an exemplary embodiment, the multilayer tubing may be used in applications such a household wares, industrial, wastewater, digital print equipment, automotive, or other applications where chemical resistance, and/or low permeation to gases and hydrocarbons are desired.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the items as listed below.

Embodiment 1. A multilayer tube includes: an inner layer including a crosslinked fluoroelastomer rubber; and an outer layer including a crosslinked non-fluoroelastomer rubber, wherein the multilayer tube has a shore A hardness of about 40 to about 90.

Embodiment 2. A method of forming a multilayer tube includes: providing an inner layer including a crosslinked fluoroelastomer rubber; and providing an outer layer including a crosslinked non-fluoroelastomer rubber, wherein the multilayer tube has a shore A hardness of about 40 to about 90.

Embodiment 3. The multilayer tube or the method of forming the multilayer tube of any of the preceding embodiments, wherein the crosslinked fluoroelastomer rubber includes at least two monomer units, wherein the monomer units include vinylidene fluoride, hexafluoropropylene, tetrafluoroethylene, perfluoromethylvinyl ether, ethylene, polypropylene, or combination thereof, wherein at least one monomer unit of the fluoroelastomer includes a fluorine moiety.

Embodiment 4. The multilayer tube or the method of forming the multilayer tube of embodiment 3, wherein the crosslinked fluoroelastomer rubber includes a terpolymer of ethylene, tetrafluoroethylene (TFE), and perfluoromethylvinyl ether (PMVE).

Embodiment 5. The multilayer tube or the method of forming the multilayer tube of any of the preceding embodiments, wherein the inner layer has a shore A hardness of less than about 80, such as about 40 to about 80, or even about 40 to about 60.

Embodiment 6. The multilayer tube or the method of forming the multilayer tube of any of the preceding embodiments, wherein the crosslinked fluoroelastomer rubber has a nominal polymer fluorine content of 67 weight %.

Embodiment 7. The multilayer tube or the method of forming the multilayer tube of any of the preceding embodiments, wherein the crosslinked fluoroelastomer rubber has a percent volume change in a chemical solution with a pH of about 1 to about 14 for 168 hours at 158° F. of no greater than 20%, or even no greater than 15%.

Embodiment 8. The multilayer tube or the method of forming the multilayer tube of any of the preceding embodiments, wherein the crosslinked fluoroelastomer rubber has a percent volume change in a small molecule formulation for 168 hours at 73° F. of no greater than 100%, such as no greater than 50%, or even not greater than 25%.

Embodiment 9. The multilayer tube or the method of forming the multilayer tube of any of the preceding embodiments, wherein the crosslinked fluoroelastomer rubber has a percent volume change in an oxidizer for 168 hours at 73° F. of no greater than 30%, such as no greater than 20%, or even no greater than 10%.

Embodiment 10. The multilayer tube or the method of forming the multilayer tube of any of the preceding embodiments, wherein the crosslinked non-fluoroelastomer rubber includes a thermoplastic polyurethane, a thermoset urethane, a diene elastomer, a styrene butadiene rubber, a polyolefin elastomer, a PVC, an isoprene, a thermoplastic isoprene composite, a natural rubber, a blend, an alloy, or any combination thereof.

Embodiment 11. The multilayer tube or the method of making the multilayer tube of embodiment 10, wherein the crosslinked non-fluoroelastomer rubber includes a diene elastomer, the diene elastomer comprising a copolymer of ethylene, propylene and diene monomer (EPDM), a thermoplastic EPDM composite, isoprene, butadiene, styrene-butadiene, or combination thereof.

Embodiment 12. The multilayer tube or the method of making the multilayer tube of any of the preceding embodiments, wherein the inner layer is thinner than the outer layer.

Embodiment 13. The multilayer tube or the method of forming the multilayer tube of any of the preceding embodiments, wherein the outer layer has a shore A hardness of less than about 80, such as about 40 to about 80, or even about 40 to about 60.

Embodiment 14. The multilayer tube or the method of forming the multilayer tube of any of the preceding embodiments, wherein the inner layer is disposed directly on the outer layer.

Embodiment 15. The multilayer tube or the method of forming the multilayer tube of embodiment 14, wherein an adhesive strength between the inner layer and the outer layer is cohesive.

Embodiment 16. The multilayer tube or the method of forming the multilayer tube of any of the preceding embodiments, wherein the inner layer further includes a curing agent.

Embodiment 17. The multilayer tube or the method of forming the multilayer tube of embodiment 16, wherein the inner layer curing agent includes a dihydroxy compound, a diamine compound, an organic peroxide, or combination thereof.

Embodiment 18. The multilayer tube or the method of forming the multilayer tube of any of the preceding embodiments, wherein the outer layer further includes a curing agent.

Embodiment 19. The multilayer tube or the method of forming the multilayer tube of embodiment 18, wherein the outer layer curing agent includes a sulfur compound, an organic peroxide, or combination thereof.

Embodiment 20. The multilayer tube or the method of forming the multilayer tube of any of the preceding embodiments, wherein the multilayer tube is a peristaltic pump tube, a chemically resistant liquid transfer tube, a warewash tube, a laundry tube, or combination thereof.

Embodiment 21. The multilayer tube or the method of forming the multilayer tube of any of the preceding embodiments, wherein the multilayer tube has a pump life of at least 6 months in a peristaltic pump.

Embodiment 22. The multilayer tube or the method of forming the multilayer tube of embodiment 21, wherein the multilayer tube has a flow rate that changes by less than about 30%, such as less than about 20%, such as less than about 10%, or even less than about 5%.

Embodiment 23. A multilayer tube includes: an inner layer including a crosslinked fluoroelastomer rubber, wherein the crosslinked fluoroelastomer rubber includes a terpolymer of an ethylene, a tetrafluoroethylene (TFE), and perfluoromethylvinyl ether (PMVE); and an outer layer including a diene elastomer.

Embodiment 24. The multilayer tube of embodiment 23, wherein the diene elastomer includes a copolymer of ethylene, propylene and diene monomer (EPDM), a thermoplastic EPDM composite, isoprene, butadiene, styrene-butadiene, or combination thereof.

Embodiment 25. The multilayer tube of embodiment 23, wherein the outer layer has a shore hardness less than a shore hardness of the inner layer.

Embodiment 26. The multilayer tube of embodiment 23, wherein the inner layer is disposed directly on the outer layer.

Embodiment 27. The method of forming the multilayer tube of embodiment 2, wherein providing the inner layer and providing the outer layer includes heating the fluoroelastomer rubber to an extrusion viscosity and the non-fluoroelastomer rubber of the outer layer to an extrusion viscosity, wherein a difference of the extrusion viscosity of the fluoroelastomer rubber and the extrusion viscosity of the non-fluoroelastomer rubber is not greater than 25%.

Embodiment 28. The method of embodiment 2, wherein providing the inner layer and the outer layer includes extruding the inner layer, the outer layer, or combination thereof.

Embodiment 29. The method of embodiment 28, wherein providing the inner layer and the outer layer includes co-extruding the inner layer and the outer layer.

Embodiment 30. The method of embodiment 2, further including curing the inner layer, the outer layer, or combination thereof.

The following examples are provided to better disclose and teach processes and compositions of the present invention. They are for illustrative purposes only, and it must be acknowledged that minor variations and changes can be made without materially affecting the spirit and scope of the invention as recited in the claims that follow.

### EXAMPLES

Tubing Structure

Inner layer: chemically resistant crosslinked fluoroelastomer (for example, FKM). FKM is a term for fluoroelastomers as defined in ASTM D1418.

Jacket layer: EPDM or other rubber compound with suitable properties for peristaltic pumping.

Interfacial bonding: inter-crosslinking between the two rubber compounds provides covalent bonding between the jacket and liner. Peel testing failure mode is cohesive.

Crosslinked fluoroelastomer composition

Composition of the fluoroelastomer composition can be varied to adjust chemical resistance for the inner layer. Examples are shown below in Table 1:

TABLE 1

| | | FKM compound examples | | | | | | |
|---|---|---|---|---|---|---|---|---|
| | | initial | | | | | | |
| | | formulation | | | | | | |
| FKM | component | 1 (parts) | 2 | 3 | 4 | 5 | 6 | 7 |
| resin | TFE/HFP/VDF (70.5% F) | 100 | | | | | | |
| | VDF/TFP | | 100 | | | | | 100 |
| | TFE/HFP/VDF/CSM 70% F | | | 100 | | 100 | 100 | |
| | TFE/ethylene/PMVE, CSM | | | | 100 | | | |
| filler | Carbon black (NSA = 8 m²/g) | 10 | 10 | 10 | 10 | | | |
| | Carbon black (NSA = 29 m²/g) | | | | | 6 | | |
| | Carbon black (NSA = 78 m²/g) | | | | | | 5 | 5 |
| cure (peroxide) | 2,5-dimethyl-2,5 di-(t-butylperoxy) hexane | 3 | 3 | 3 | 3 | 3 | 3 | 3 |
| co-agent | Trially isocyanurate | 4 | 4 | 4 | 4 | 4 | 4 | 4 |
| process aids | Carnuba wax | 1 | 1 | 1 | 1 | 1 | 1 | 1 |
| | polyethylene process aid | 1 | 1 | 1 | 1 | 1 | 3 | 1 |

Examples 1 and 3 are peroxide-cured, type II FKMs reinforced with carbon black. Each uses a different grade of base FKM. These type II grades utilize minimal VDF comonomer in order to increase base resistance. Example 2 is a copolymer designed for base resistance. Example 4 is a type V FKM that can be used to maximize base resistance. In Examples 5 and 6, alternate grades of carbon black (higher surface area) can be used which provide similar hardness values at a lower filler loading. All of the above examples are formulated to provide a shore durometer of 55-65A. The compounds can be mixed on a two roll mill or with an internal mixer.

Composition of EPDM compounds for the jacket layer can be seen in Table 2:

TABLE 2

| | | Initial | No | Alternate | | | | | |
|---|---|---|---|---|---|---|---|---|---|
| | | formulation | lubricant | peroxide | Carbon black | | Alternate EPDMs | | |
| EPDM | | 1 | 2 | 3 | 4 | 5 | 6 | 7 | 8 |
| resin | EPDM (A)* | 100.0 | 100.0 | 100.0 | 100 | 100 | | | |
| | EPDM (B)* | | | | | | 100 | | |
| | EPDM (C)* | | | | | | | 100 | |
| | EPDM (D)* | | | | | | | | 100 |
| Reinforcement | Kaolin | 133.3 | 133.3 | 133.3 | | | 133.3 | 133.3 | 133.3 |
| | Carbon | | | | 36 | 20 | | | |
| | black* | | | | | | | | |
| Antioxidant | Antioxidant | 0.7 | 0.7 | 0.7 | 0.7 | 0.7 | 0.7 | 0.7 | 0.7 |
| | 1 | | | | | | | | |
| | Aromatic | 6.7 | 6.7 | 6.7 | 6.7 | 6.7 | 6.7 | 6.7 | 6.7 |
| | hydrocarbon | | | | | | | | |
| | resin | | | | | | | | |
| Co-agent | Zinc | 3.3 | 3.3 | 3.3 | 3.3 | 3.3 | 3.3 | 3.3 | 3.3 |
| | diacrylate | | | | | | | | |
| | compound | | | | | | | | |
| Lubricant | Zinc | 1.3 | | 1.3 | 1.3 | 1.3 | 1.3 | 1.3 | 1.3 |
| | stearate | | | | | | | | |
| Oil | Mineral oil | 20.0 | 20.0 | 20.0 | 20 | 20 | 20 | 20 | 20 |
| Color MB | Colorant | 3.3 | 3.3 | 3.3 | | | 3.3 | 3.3 | 3.3 |
| Cure | Dicumyl | 1.3 | 1.3 | | | | | | |
| | peroxide | | | | | | | | |
| | (160 C. min | | | | | | | | |
| | 148 C.) | | | | | | | | |
| | Peroxide | | | 1.8 | 1.6 | 1.6 | 1.6 | 1.6 | 1.6 |
| | (DTBPH) | | | | | | | | |

*EPDM (A) (<2% ENB, <55% ethylene, <60 MU)
EPDM (B) (4.7% ENB, 70% ethylene, crystalline)
EPDM (C) (4.7% ENB, 70% ethylene, crystalline)
EPDM (D) (8%, 60% ethylene, amorphous)
Carbon black (NSA = 85 m²/g)
Antioxidant 1 = zinc-4- and 5-methyl-2-mercaptobenzimidazole (ZMMBI)

Sample 1 shows the initial formulation used as part of the invention. Sample 2 is a version that does not contain lubricant. Sample 3 uses an alternate, non-vinyl-specific peroxide for curing. The same peroxide is used for Samples 4-8. Samples 4 and 5 utilize carbon black reinforcement. Samples 6, 7 and 8 look at the effect of molecular weight, norbornene content, and crystallinity. Higher molecular weight compound will provide improved physical properties such as tensile strength, resilience, and tear resistance. Higher norbornene content facilitates higher degrees of crosslinking in the compound. Alternately, a peroxide curable jacket compound based on natural rubber or high cis-polyisoprene or high cis-polybutadiene can be utilized. Such materials have high resilience, tensile strength, tear strength, and compression set resistance compared to EPDM. These properties are desirable in pump tubing applications.

The jacket and liner compounds are tested for the following properties in Table 3:

TABLE 3

| Properties | Test Procedure |
|---|---|
| Compression Set | ASTM D3955, Method B (25% deflection) |
| Resilience | ASTM D2632 |
| Hardness | ASTM D2240, durometer A |
| Mooney Scorch | ASTM D1646, using the small rotor. Minimum |
| | viscosity and |
| Mooney Viscosity | ASTM D1646, ten pass 100° C. (212° F.) and |
| | 121° C. (250° F.) |
| ODR | ASTM D2084 |
| Stress/Strain Properties | ASTM D412, pulled at 8.5 mm/sec (20 in/min) |
| 100% Modulus | |
| Tensile Strength | |
| Elongation at Break | |
| Hysteresis | SG internal method |
| Volume Change in Fluids | ASTM D471 |

Tube fabrication

Coextrusion of the jacket and liner material can be accomplished using single screw extruders with an L/D of 16-20:1. Typical processing conditions are shown below in Table 4:

TABLE 4

| | FKM | EPDM |
|---|---|---|
| Temperature screw (° C.) | 90 | 40 |
| Temperature barrel (° C.) | from 80 to 95 | from 50 to 70 |

| | |
|---|---|
| Temperature Head (° C.) | 90 |
| pressure cross head (Bars) | between 80 and 100 |
| Speed ligne (m/mn) | 3 |

The materials are coextruded through a tubing, coextrusion die to form a tubing of the following structures seen in Table 5:

TABLE 5
Extruded tubing dimensions

| | 1 | 2 | 3 |
|---|---|---|---|
| Inner diameter (in) | 0.25 | 0.25 | 0.25 |
| Outer diameter (in) | 0.448 | 0.448 | 0.448 |
| Wall (in) | 0.099 | 0.099 | 0.099 |
| Liner thickness (in) | 0.01 | 0.015 | 0.02 |

The tubing can be utilized within a peristaltic pump. Table 6 shows representative chemical resistance properties for tubing lined with base resistant FKM compounds (examples 2 and 4).

TABLE 6
Relative Chemical Resistant Properties for Liner Material*

| Acids | | | Bases | | | | | |
|---|---|---|---|---|---|---|---|---|
| concentrated | medium | weak | concentrated | medium | weak | Salts | Alcohols | Ketones |
| E | E | E | E | E | E | E | F | U |

| | | |
|---|---|---|
| Aliphatic | Hydrocarbons Aromatic | Halogenated |
| F | F | F |

E = Excellent;
F = Fair;
U = Unsatisfactory
*All tests conducted at room temperatures

Tube Properties

Table 7 shows typical bend radius values for the tubing.

TABLE 7

| | | | Minimum bend |
|---|---|---|---|
| I.D. (inches) | O.D. (inches) | Wall (inches) | radius (inches) |
| ⅛ | ¼ | 1/16 | ½ |
| ¼ | ⅜ | 1/16 | 1 |
| ⅜ | ½ | 1/16 | 1¾ |
| ½ | ¾ | ⅛ | 2 |

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A multilayer tube comprises:
an inner layer comprising a crosslinked fluoroelastomer rubber; and
an outer layer comprising a crosslinked non-fluoroelastomer rubber, wherein the multilayer tube has a shore A hardness of about 40 to about 90.

2. The multilayer tube of claim 1, wherein the crosslinked fluoroelastomer rubber comprises at least two monomer units, wherein the monomer units comprise vinylidene fluoride, hexafluoropropylene, tetrafluoroethylene, perfluoromethylvinyl ether, ethylene, polypropylene, or combination thereof, wherein at least one monomer unit of the fluoroelastomer comprises a fluorine moiety.

3. The multilayer tube of claim 2, wherein the crosslinked fluoroelastomer rubber comprises a terpolymer of ethylene, tetrafluoroethylene (TFE), and perfluoromethylvinyl ether (PMVE).

4. The multilayer tube of claim 1, wherein the inner layer has a shore A hardness of less than about 80, such as about 40 to about 80, or even about 40 to about 60.

5. The multilayer tube of claim 1, wherein the crosslinked fluoroelastomer rubber has a nominal polymer fluorine content of 67 weight %.

6. The multilayer tube of claim 1, wherein the crosslinked fluoroelastomer rubber has a percent volume change in a chemical solution with a pH of about 1 to about 14 for 168 hours at 158° F. of no greater than 20%, or even no greater than 15%.

7. The multilayer tube of claim 1, wherein the crosslinked fluoroelastomer rubber has a percent volume change in a small molecule formulation for 168 hours at 73° F. of no greater than 100%, such as no greater than 50%, or even not greater than 25%.

8. The multilayer tube of claim 1, wherein the crosslinked non-fluoroelastomer rubber comprises a thermoplastic polyurethane, a thermoset urethane, a diene elastomer, a styrene butadiene rubber, a polyolefin elastomer, a PVC, an isoprene, a thermoplastic isoprene composite, a natural rubber, a blend, an alloy, or any combination thereof.

9. The multilayer tube of claim 8, wherein the crosslinked non-fluoroelastomer rubber comprises a diene elastomer, the diene elastomer comprising a copolymer of ethylene, propylene and diene monomer (EPDM), a thermoplastic EPDM composite, isoprene, butadiene, styrene-butadiene, or combination thereof.

10. The multilayer tube of claim 1, wherein the inner layer is disposed directly on the outer layer.

11. The multilayer tube of claim 10, wherein an adhesive strength between the inner layer and the outer layer is cohesive.

12. The multilayer tube of claim 1, wherein the inner layer further comprises a curing agent.

13. The multilayer tube of claim 1, wherein the outer layer further comprises a curing agent.

14. The multilayer tube of claim 1, wherein the multilayer tube is a peristaltic pump tube, a chemically resistant liquid transfer tube, a warewash tube, a laundry tube, or combination thereof.

15. The multilayer tube of claim 1, wherein the multilayer tube has a pump life of at least 6 months in a peristaltic pump.

16. The multilayer tube of claim 15, wherein the multilayer tube has a flow rate that changes by less than about 30%, such as less than about 20%, such as less than about 10%, or even less than about 5%.

17. A method of forming a multilayer tube comprises:
providing an inner layer comprising a crosslinked fluoroelastomer rubber; and
providing an outer layer comprising a crosslinked non-fluoroelastomer rubber, wherein the multilayer tube has a shore A hardness of about 40 to about 90.

18. A multilayer tube comprises:
an inner layer comprising a crosslinked fluoroelastomer rubber, wherein the crosslinked fluoroelastomer rubber comprises a terpolymer of an ethylene, a tetrafluoroethylene (TFE), and perfluoromethylvinyl ether (PMVE); and
an outer layer comprising a diene elastomer.

19. The multilayer tube of claim 18, wherein the diene elastomer comprises a copolymer of ethylene, propylene and diene monomer (EPDM), a thermoplastic EPDM composite, isoprene, butadiene, styrene-butadiene, or combination thereof.

20. The multilayer tube of claim 18, wherein the outer layer has a shore hardness less than a shore hardness of the inner layer.
